(19) United States
(12) Patent Application Publication
(10) Pub. No.: US 2007/0211941 A1
(43) Pub. Date: Sep. 13, 2007

(54) Image forming process control apparatus, image forming apparatus, image forming process control method and program

(75) Inventor: Yuusuke Suzuki, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/373,580

(22) Filed: Mar. 10, 2006

(51) Int. Cl. G06K 9/34

(52) U.S. Cl. 382/180

(57) ABSTRACT

A technology for solving inconvenience such that when executing an image forming process on the basis of PDL data using a non-standard command, the image forming process cannot be executed due to a description error of the non-standard command of the PDL data even though a description of a standard command thereof is correct is provided. An error information acquiring unit for acquiring information relating to errors occurred during the image forming process; a process restriction unit for restricting execution of the image forming process on the basis of image data from which error information is acquired when the error information is acquired by the error information acquiring unit; an error content determination unit for determining whether or not the error information acquired by the error information acquiring unit is a grammatical error relating to a predetermined extended function in a page description language; and a restriction releasing unit for releasing restriction of execution of the image forming process by the process restriction unit when the error content determination unit determines that the error information acquired by the error information acquiring unit is the grammatical error relating to the predetermined extended function are provided.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The present invention relates to control of an image forming process and, more specifically, a technology for controlling the image forming processing in a case in which an error is occurred during the image forming process.

2. Description of the Related Art

When performing an image forming process on the basis of PDL data with an image forming apparatus, there is a case in which a non-standard advanced function (hereinafter, referred to as non-standard command), such as a blending function for displaying, for example, contours of two graphics being gradually combined is used in addition to normally-used functions such as a simple layout of graphics or specification of a font of characters.

In the image forming apparatus, when there is no description indicating usage of the non-standard command in the PDL data, the image forming process is normally performed by a standard function of a printer controller. On the other hand, when there is a description indicating the usage of a non-standard command in the PDL data, the non-standard command support function of the printer controller is turned ON to perform the image forming process using the advance function indicated by the non-standard command.

When there is a description which violates grammar in the PDL data that is to be used for the image forming process, it is determined that the image forming process on the basis of the PDL data cannot be executed and an error notification is issued.

As a technology for coping with the occurrence of the grammatical error in the PDL data, a technology for performing the process by switching a plurality of interpreters while making an attempt to check whether printing data can be interpreted or not (JP-A-2001-222396), a technology for converting languages and switching the font to be used only by entering a language that a user is going to use once (JP-A-10-134061), and a technology to perform the process by passing the PDL data to be entered through a plurality of PDL analyzing units and determining which language is used for describing the PDL data (JP-A-2000-305739) are known.

However, with the technology for performing the process by switching the plurality of language interpreters while making an attempt to check whether the PDL data to be entered can be interpreted or not, if a grammatical error that relates to an extended command of the identical language is occurred, the process is moved to another language interpreter, and hence printing cannot be achieved. Also in a case in which a grammatical error in association with a description error of the PDL data is occurred, printing cannot be achieved. Since a failure of grammatical interpretation of the PDL data is employed as a trigger of the language switching, the description error of the PDL data cannot be outputted as an error page, and hence the user can hardly figure out the reason why printing is failed.

When printing the PDL data in which the non-standard command is used as described above as well, it is not necessarily true that the user always desires printing results in which such an advanced non-standard command is accurately reflected.

In order to solve the above-described problems, it is an object of the present invention to provide a technology for solving inconvenience such that when executing an image forming process on the basis of PDL data using a non-standard command, the image forming process cannot be executed due to a description error of the non-standard command of the PDL data even though a description of a standard command thereof is correct.

### DESCRIPTION OF THE DRAWINGS

FIG. 1 is an explanatory functional block diagram of an image forming process control device according to a first embodiment of the present invention and an image forming apparatus having the same;

FIG. 2 is a drawing showing an example of a source code of PDL data in which a non-standard command is used;

FIG. 3 is a flowchart for explaining a flow of a process in the image forming process control device (image forming process control method) in this embodiment;

FIG. 4 is a flowchart for explaining a flow of a process in the image forming process control device (image forming process control method) according to a second embodiment of the present invention;

FIG. 5 is a drawing showing an example of the source code of the PDL which may cause a grammatical error in an argument checking process; and

FIG. 6 is a flowchart for explaining a flow of a process in the image forming process control device (image forming process control method) according to a third embodiment of the present invention.

### DETAILED DESCRIPTION OF THE INVENTION

Throughout this description, the embodiments and examples shown should be considered as exemplars, rather than limitations on the apparatus, methods, and programs of the present invention.

### First Embodiment

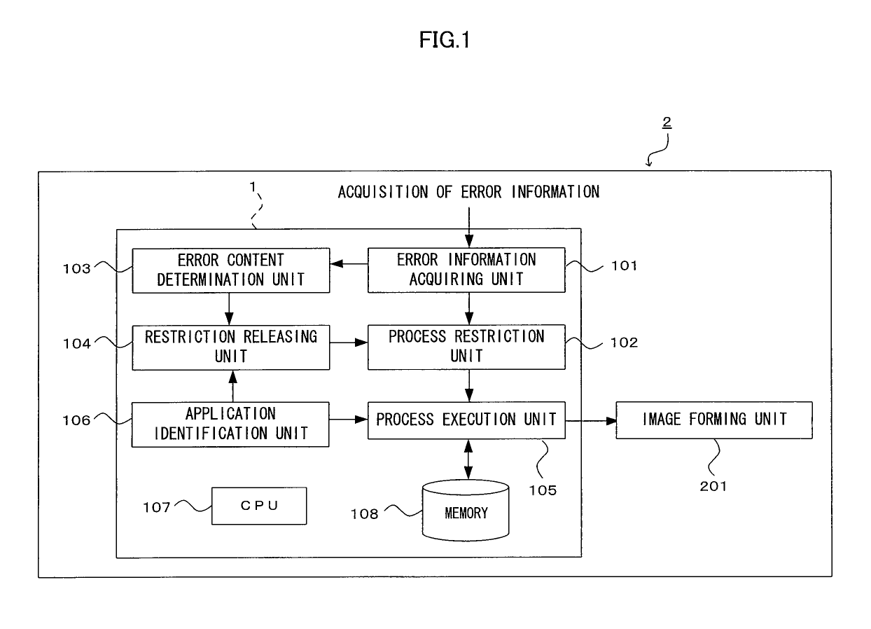

FIG. 1 is a functional block diagram for explaining an image forming process control device according to a first embodiment of the present invention and an image forming apparatus having the same.

An image forming apparatus 2 in this embodiment includes an image forming process control device 1 and an image forming unit 201 for executing an image forming process on the basis of a command instructing to execute the image forming process issued from the image forming process control device 1. The image forming apparatus 2 executes the image forming process on the basis of PDL data or the like in which printing contents transmitted from an external equipment such as a PC communicably connected with the image forming apparatus 2 are written in a printer description language. The image forming apparatus 2 here is composed, for example, of an MFP (Multi Function Peripheral).

The image forming process control device 1 according to this embodiment includes an error information acquiring unit 101, a process restriction unit 102, an error content determination unit 103, a restriction releasing unit 104, a process execution unit 105, an application identification unit 106, a CPU 107 and a MEMORY 108.

The error information acquiring unit 101 acquires information relating to errors occurred in the image forming process executed by the image forming apparatus 2 from log information or the like relating to errors accumulated in a storage area in the image forming apparatus 2. The log information does not have to be acquired necessarily from the image forming apparatus 2, and may be acquired from the storage area arranged on the outside of the image forming apparatus 2.

When the error information is acquired by the error information acquiring unit 101, the process restriction unit 102 restricts execution of the image forming process on the basis of the image data from which the error information is acquired by interrupting or terminating the same.

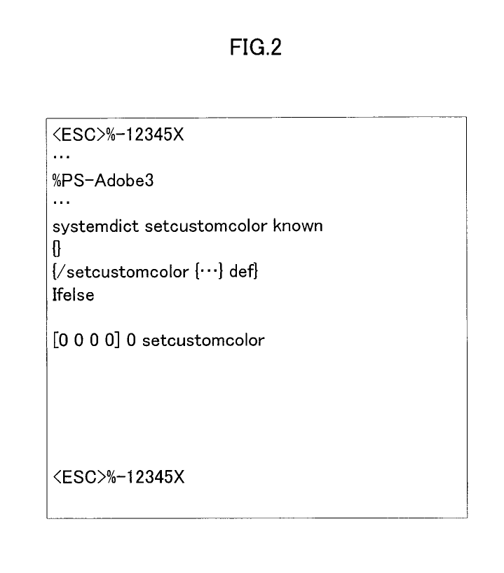

The error content determination unit 103 determines whether or not the error information acquired by the error information acquiring unit 101 is a grammatical error relating to a non-standard command (predetermined extended function) in a page description language. FIG. 2 is a drawing showing an example of a source code of the PDL data in which the non-standard command is used.

When the error information acquired by the error information acquiring unit 101 is determined to be the grammatical error relating to the non-standard command by the error content determination unit 103, the restriction releasing unit 104 prevents (releases) the process restriction unit 102 from restricting the execution of the image forming process.

The process execution unit 105 causes the image forming unit 201 to execute the image forming process on the basis of the image data whose restriction of execution of the image forming process by the process restriction unit 102 is released by the restriction releasing unit 104.

The application identification unit 106 identifies an application that has given an instruction to execute the image forming process from which the error information is acquired by the error information acquiring unit 101. The type of the application acquired here includes, for example, graphic painting software, word processing software and image editing software.

The CPU 107 has a role to execute various processes in the image forming process control device and the image forming apparatus, and also a role to realize various functions by executing programs stored in the MEMORY 108. The MEMORY 108 includes, for example, an HDD, a ROM, a RAM, and so on, and has a role to store various information or programs used in the image forming process control device and the image forming apparatus. The MEMORY 108 includes a spooling area secured therein for temporarily storing the PDL data received from the external devices.

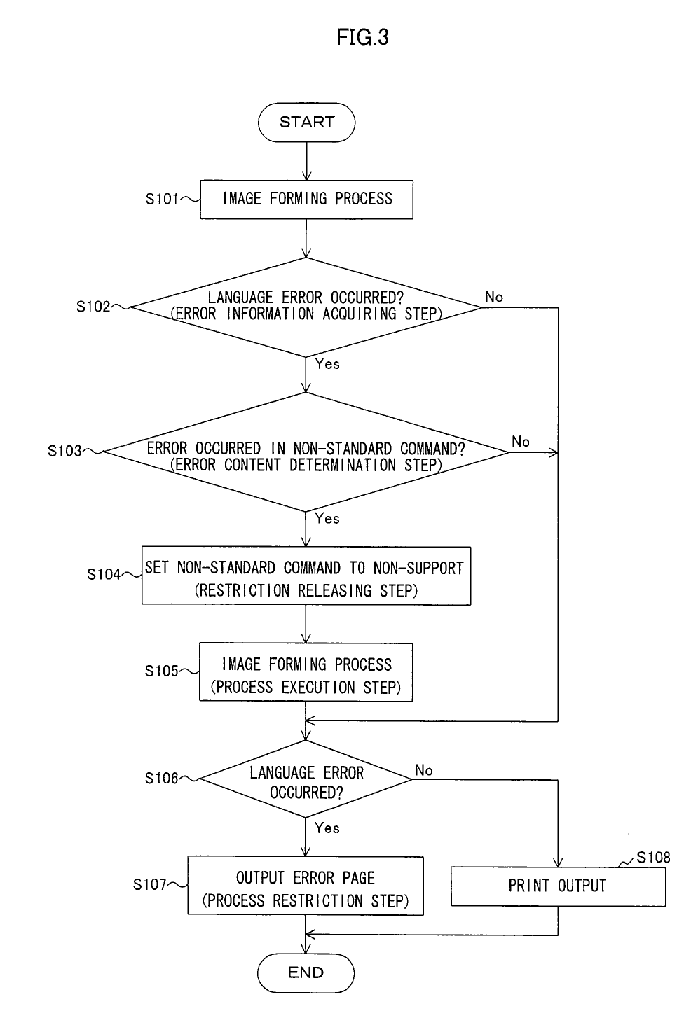

FIG. 3 is a flowchart for explaining a flow of a process in the image forming process control device in this embodiment (image forming process control method).

The image forming apparatus 2 starts the image forming process on the basis of the PDL data acquired from the external device or the like (S101). Then, whether or not the grammatical error of the PDL is occurred during the image forming process is determined, and if the grammatical error is occurred, the error information acquiring unit 101 acquires information about the error in question (error information acquiring step) (S102). Subsequently, the error content determination unit 103 determines whether or not the grammatical error in question is the grammatical error relating to the non-standard command in the page description language (error content determination step) (S103). Here, when the grammatical error in question relates to the non-standard command, the restriction releasing unit 104 performs a setting to invalidate interpretation of the non-standard command (to release the restriction of execution of the image forming process in the process restriction step) (S104). With this setting, the invalidated command is not treated as a command involved in interpretation of the PDL in the image forming process from then on.

Subsequently, the process execution unit 105 makes the image forming unit 201 execute the image forming process again (process execution step) (S105). After having executed the image forming process, the language error is determined again (S106), and if the error is occurred (Yes in S106), the grammatical error is outputted, and execution of the image forming process on the basis of the image data from which the error information is acquired is restricted (process restriction step) (S107). Otherwise, the formed image is outputted (S108).

In this manner, according to this embodiment, when the language error is occurred while executing the image forming process for the printing data of the PDL including the error relating to the usage of the non-standard command, the non-standard command is invalidated and the image forming process is executed again so that the occurrence of the error relating to the usage of the non-standard command can be avoided.

### Second Embodiment

Subsequently, a second embodiment of the present invention will be described. This embodiment is a modification of the first embodiment described above, and the basic configurations of the device are the same as those in the first embodiment. This embodiment is different from the first embodiment specifically in behavior of the process execution unit 105. In the description below, the same parts as those described in the first embodiment are designated by the same reference numerals and descriptions are omitted.

The image forming process control device in this embodiment enables execution of the image forming process even when a command having an error in specification of the usage is included in the PDL data by changing interpretation of the image forming process in a form against the language specification and executing the image forming process again when a language error is occurred during the image forming process for printing the PDL data.

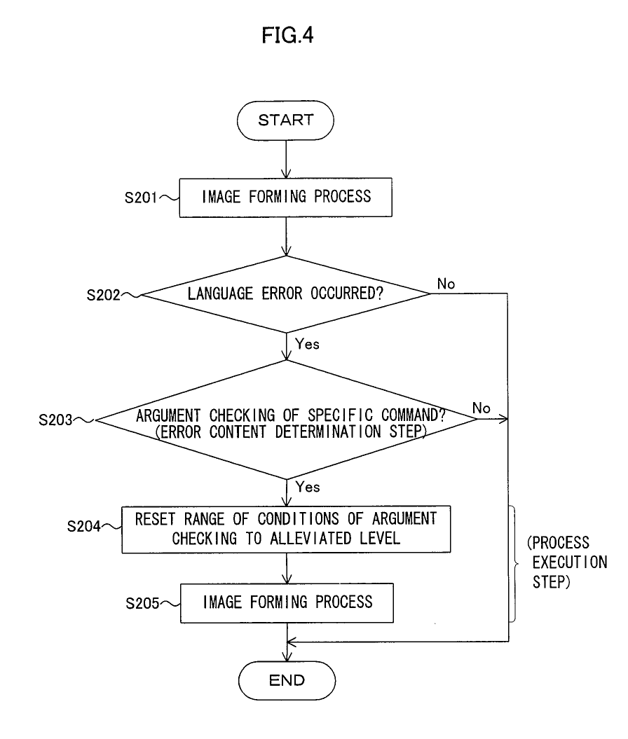

Referring to the flowchart in FIG. 4, a flow of a process in the image forming process control device in this embodiment (image forming process control method) will be described.

Since S201 to S202 shown in FIG. 4 are the same as S101 to S102 shown in FIG. 3, description will be omitted.

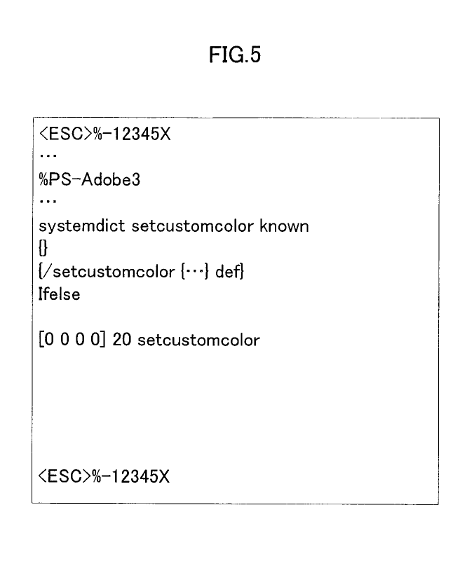

) The error content determination unit 103 determines the contents of the occurred error (error content determination step) (S203). Whether or not the cause of occurrence of the grammatical error exists in the argument checking process performed when a specific command as the non-standard command is executed is determined. An example of the source code of the PDL that may cause the grammatical error in the argument checking process is shown in FIG. 5. In FIG. 5, a command on a line in which “[0000]20 setcustomcolor” is described is the non-standard command, and an example in which a numerical value “20” which should not be included normally is described is shown. More specifically, when a predetermined numerical value range of the arguments in which the value “20” is assigned is between 0 and 1, the command on this line includes the grammatical error.

When the occurred error is the one which is occurred during the argument checking process of the non-standard command, conditions of the argument checking are reset to an alleviated level in comparison with a normal level and the determination process is changed so as to alleviate condition determination of the argument checking (S204). Then, the process executing unit 105 makes the image forming unit 201 execute the image forming process again (S205).

To alleviate the conditions of the argument checking (syntax checking of the PDL), for example, means to alleviate a level of the syntax checking so that the grammatical error can hardly be occurred, to widen the numerical value range of the arguments used in the non-standard command, or to change the values of the arguments described in the PDL data.

More specifically, when the error content determination unit 103 determines that the error information acquired by the error information acquiring unit 101 relates to the fact that the argument used in the non-standard command in the page description language is not within the predetermined numerical value range (see FIG. 5), the process execution unit 105 changes the argument in question into the predetermined numerical value that falls within the predetermined numerical value range and hence is normally used (“0”, for example), and causes the image forming process to be executed again (process execution step).

When the error content determination unit 103 determines that the error information acquired by the error information acquiring unit 101 relates to the fact that the value of the argument required for the non-standard command in the page description language is too small, the process execution unit 105 causes the image forming process to be executed again using the predetermined arguments instead of the arguments of the missing number (process execution step). The predetermined value that the process execution unit 105 uses for correcting the command in which the grammatical error is occurred when checking the argument is stored in advance, for example, in the MEMORY 108.

As another example for alleviating the conditions of the grammatical check, there is a method of determining the rate of concordance with a spelling of a predetermined command that might be used when there is a command with spelling error contained in the command described in the PDL, estimating a character string whose rate of concordance is higher than a certain threshold value is the command in question and proceeding the grammatical check.

### Third Embodiment

Subsequently, a third embodiment of the present invention will be described. This embodiment is a modification of the first embodiment described above, and the basic configurations of the device are the same as those in the first embodiment. This embodiment is different from the first embodiment specifically in behavior of the process execution unit 105. In the description below, the same parts as those described in the first embodiment are designated by the same reference numerals and descriptions are omitted.

This embodiment is characterized in that the condition determination of the command at the time of the image forming process is alleviated by identifying the application that has executed the printing operation. Accordingly, printing can be achieved without causing grammatical errors (without necessity of stopping the image forming process) even in the case of printing from the application having an advanced function which is apt to cause the language error.

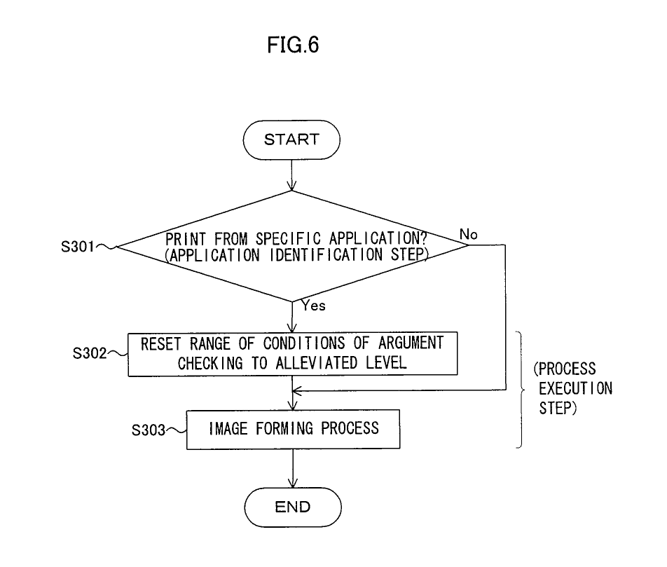

Referring now to a flowchart shown in FIG. 6, a flow of a process in the image forming process control device (image forming process control method) in this embodiment will be described.

At the beginning of the image forming process, the application identification unit 106 scans printing data used for printing and determines whether or not the printing command for the printing data in question is issued from a specific application (application identification step) (S301).

When it is determined that the application is the specific one as a result of determination (Yes in S301), the level of the condition determination of the argument checking (grammatical check) of the command in the page description language is alleviated and the condition determination process is reset to a loosen level (S302). With this setting, the process is proceeded in a state in which the determination range of the condition determination process of the preset command is changed to the reset range in the image forming process from then on. After having set, the process execution unit 105 makes the image forming unit 201 execute the image forming process (S303).

In other words, the restriction releasing unit 104 makes the process restriction unit 102 restrict execution of the image forming process when the application identified by the application identification unit 106 is a predetermined application having an advanced function (for example, graphic painting software), and prevents the process restriction unit 102 from executing restriction of execution of the image forming process when it is not the predetermined application (restriction releasing step). Generally, it is highly likely that users who operate the application having the advanced graphic function have a high level knowledge about the page description language in comparison with general users. Therefore, in a case of the printing process using such an application with the advanced function, it is considered that the user can understand the error information and hence the error information is notified and the image forming process is interrupted. On the other hand, in a case of the printing process using an application which only has a standard drawing function, it is considered that the user is not likely to understand the error information even though it is outputted, and hence the printing process is continuously executed.

In addition, in the case in which the application identified by the application identification unit 106 is the predetermined application having the advanced function, it is possible to configure in such a manner that the restriction releasing unit 104 releases the restriction of execution of the image forming process by the process restriction unit 102, and the process execution unit 105 causes the image forming process from which the error information is acquired to be executed without using the non-standard command (restriction releasing step).

The respective steps in the process in the image forming process control device (image forming process control method) in the respective embodiments described above are realized by making the CPU 107 execute the image forming process control program stored in the MEMORY 108.

Although the case in which the function for implementing the invention is stored in the interior of the device in advance has been described in the embodiments, the invention is not limited thereto, and the same function can be downloaded from a network to the device, or a recording medium in which the same function is stored may be installed in the device. The form of the recording medium is not limited as long as it can store the program and is a recording medium which can be read by the device, such as CD-ROMs. The function that is obtained by installation or downloading in advance as described above may also be the one that realizes the function in coordination with an OS (Operation System) in the device or the like.

In this manner, according to the respective embodiments described above, even when the printing data including the grammatical error relating to the non-standard command created by the application or the printer driver become an object of the image forming process in itself, the image forming process can be executed without interrupting the image forming process completely.

Although the present invention has been described in detail according to the specific embodiments, it is clear for those skilled in the art that various changes or modifications can be made without departing from the spirit and scope of the present invention.

As described thus far, according to the present invention, there is provided a technology for solving the problem such that when executing an image forming process on the basis of PDL data using a non-standard command, an image forming process cannot be executed due to a description error of the non-standard command of the PDL data even though a description of a standard command thereof is correct.

It is claimed:

1. An image forming process control device comprising:
an error information acquiring unit that acquires information relating to errors occurred during an image forming process;
a process restriction unit that restricts execution of the image forming process on the basis of image data from which error information is acquired in a case in which the error information is acquired by the error information acquiring unit;
an error content determination unit that determines whether or not the error information acquired by the error information acquiring unit is a grammatical error relating to a predetermined extended function in a page description language; and
a restriction releasing unit that releases restriction of execution of the image forming process by the process restriction unit when the error content determination unit determines that the error information acquired by the error information acquiring unit is the grammatical error relating to the predetermined extended function.

2. The image forming process control device according to claim 1, comprising:
a process execution unit that executes the image forming process on the basis of the image data whose restriction of execution of the image forming process by the process restriction unit is released by the restriction releasing unit.

3. The image forming process control device according to claim 2, wherein when the error information acquired by the error information acquiring unit is determined to be related to the fact that an argument used in the predetermined extended function in the page description language does not fall within a predetermined numerical value range by the error content determination unit, the process execution unit changes the argument to a predetermined numerical value that falls within the predetermined numerical value range and executes the image forming process again.

4. The image forming process control device according to claim 2, wherein when the error content determination unit determines that the error information acquired by the error information acquiring unit relates to the fact that a value of the argument falls short of a value of the argument required for the predetermined extended function in the page description language, the process execution unit executes the image forming process again using a predetermined argument instead of the argument which falls short of the required value.

5. The image forming process control device according to claim 1, comprising:
an application identification unit that identifies an application that has given an instruction to perform the image forming process from which the error information is acquired by the error information acquiring unit,
wherein the restriction releasing unit causes the process restriction unit to restrict execution of the image forming process when the application identified by the application identification unit is a predetermined application having an advanced function, and causes the process restriction unit to release the restriction of the execution of the image forming process when the application is not the predetermined application.

6. The image forming process control device according to claim 1, comprising:
an application identification unit that identifies an application that has given an instruction to perform the image forming process from which the error information is acquired by the error information acquiring unit,
wherein the restriction releasing unit causes the process restriction unit to release the restriction of the execution of the image forming process and the process execution unit executes the image forming process from which the error information is acquired without using the predetermined extended function when the application identified by the application identification unit is a predetermined application having an advanced function.

7. An image forming apparatus comprising:
the image forming process control device according to claim 2; and
an image forming unit that performs the image forming process on the basis of a process execution command from the process execution unit.

8. An image forming process control method comprising;
an error information acquiring step that acquires information relating to errors occurred during an image forming process;
a process restriction step that restricts execution of the image forming process on the basis of image data from which error information is acquired in a case in which the error information is acquired by the error information acquiring step;
an error content determination step that determines whether or not the error information acquired by the error information acquiring step is a grammatical error relating to a predetermined extended function in a page description language; and
a restriction releasing step that releases restriction of execution of the image forming process by the process restriction step when the error content determination step determines that the error information acquired by the error information acquiring step is the grammatical error relating to the predetermined extended function.

9. The image forming process control method according to claim 8, comprising:
a process execution step that executes the image forming process on the basis of the image data whose restriction of execution of the image forming process by the process restriction step is released by the restriction releasing step.

10. The image forming process control method according to claim 9, wherein when the error information acquired by the error information acquiring step is determined to be related to the fact that an argument used in the predetermined extended function in the page description language does not fall within a predetermined numerical value range by the error content determination step, the process execution step changes the argument to a predetermined numerical value that falls within the predetermined numerical value range and executes the image forming process again.

11. The image forming process control method according to claim 9, wherein when the error content determination step determines that the error information acquired by the error information acquiring step relates to the fact that a value of the argument falls short of a value of the argument required for the predetermined extended function in the page description language, the process execution step executes the image forming process again using a predetermined argument instead of the argument which falls short of the required value.

12. The image forming process control method according to claim 8, comprising:
an application identification step that identifies an application that has given an instruction to perform the image forming process from which the error information is acquired by the error information acquiring step,
wherein the restriction releasing step causes the process restriction step to restrict execution of the image forming process when the application identified by the application identification step is a predetermined application having an advanced function, and causes the process restriction step to release the restriction of the execution of the image forming process when the application is not the predetermined application.

13. The image forming process control method according to claim 8, comprising:
an application identification step that identifies an application that has given an instruction to perform the image forming process from which the error information is acquired by the error information acquiring step,
wherein the restriction releasing step causes the process restriction step to release the restriction of the execution of the image forming process and the process execution step executes the image forming process from which the error information is acquired without using the predetermined extended function when the application identified by the application identification step is a predetermined application having an advanced function.

14. An image forming process control program for causing a computer to execute:
an error information acquiring step that acquires information relating to errors occurred during an image forming process;
a process restriction step that restricts execution of the image forming process on the basis of image data from which error information is acquired in a case in which the error information is acquired by the error information acquiring step;
an error content determination step that determines whether or not the error information acquired by the error information acquiring step is a grammatical error relating to a predetermined extended function in a page description language; and
a restriction releasing step that releases restriction of execution of the image forming process by the process restriction step when the error content determination step determines that the error information acquired by the error information acquiring step is the grammatical error relating to the predetermined extended function.

15. The image forming process control program according to claim 14, comprising:
a process execution step that executes the image forming process on the basis of the image data whose restriction of execution of the image forming process by the process restriction step is released by the restriction releasing step.

16. The image forming process control program according to claim 15, wherein when the error information acquired by the error information acquiring step is determined to be related to the fact that an argument used in the predetermined extended function in the page description language does not fall within a predetermined numerical value range by the error content determination step, the process execution step changes the argument to a predetermined numerical value that falls within the predetermined numerical value range and executes the image forming process again.

17. The image forming process control program according to claim 15, wherein when the error content determination step determines that the error information acquired by the error information acquiring step relates to the fact that a value of the argument falls short of a value of the argument required for the predetermined extended function in the page description language, the process execution step executes the image forming process again using a predetermined argument instead of the argument which falls short of the required value.

18. The image forming process control program according to claim 14, comprising:
an application identification step that identifies an application that has given an instruction to perform the image forming process from which the error information is acquired by the error information acquiring step,
wherein the restriction releasing step causes the process restriction step to restrict execution of the image forming process when the application identified by the application identification step is a predetermined application having an advanced function, and causes the process restriction step to release the restriction of the execution of the image forming process when the application is not the predetermined application.

19. The image forming process control program according to claim 14, comprising:
an application identification step that identifies an application that has given an instruction to perform the image forming process from which the error information is acquired by the error information acquiring step,
wherein the restriction releasing step causes the process restriction step to release the restriction of the execution of the image forming process and the process execution step executes the image forming process from which the error information is acquired without using the predetermined extended function when the application identified by the application identification step is a predetermined application having an advanced function.
